(19) United States
(12) Patent Application Publication
(10) Pub. No.: US 2023/0066025 A1
(43) Pub. Date: Mar. 2, 2023

(54) VEHICLE-MOUNTED ENERGY-STORING POWER SUPPLY

(71) Applicant: Chongqing Diange Technology (Group) Co.Ltd., Chongqing (CN)

(72) Inventors: Xiaoming Gong, Chongqing (CN); Liang Wu, Chongqing (CN); Liang Tan, Chongqing (CN); Jin Yang, Chongqing (CN); Zhicheng Wei, Chongqing (CN)

(21) Appl. No.: 17/704,333

(22) Filed: Mar. 25, 2022

(30) Foreign Application Priority Data
Aug. 30, 2021 (CN) 202122062532.6

(51) Int. Cl. B60R 16/04; H01M 50/249

(52) U.S. Cl. CPC B60R 16/04; H01M 50/249; H01M 2220/20

(57) ABSTRACT

The present disclosure relates to a vehicle-mounted energy-storing power supply. The vehicle-mounted energy-storing power supply comprises a power supply main body disposed to set the accumulator; a bottom cover disposed at the bottom of the power supply main body; a heat dissipating and dustproof device disposed on the bottom cover which comprises a sealed outer frame and a cooling tube, the cooling tube is filled with coolant; wherein the sealed outer frame is a hollow structure for disposing the cooling tube to cool the accumulator. The present disclosure exists space between an accumulator and an bottom cover, and meanwhile disposes positioned space and a cooling tube between the accumulator and the bottom cover, so that the accumulator can quickly be cooled and the cooling tube can continuously cool the accumulator then ensuring the accumulator normally operate.

### CROSS-REFERENCE TO RELATED APPLICATIONS

This application claims a priority of the following Chinese Patent Application: CN 202122062532.6 filed on Aug. 30, 2021, the disclosures of which are incorporated herein in their entirety by reference.

### BACKGROUND

### Technical Field

The present disclosure relates to a field of the energy-storing power supply technology, and more particularly to a vehicle-mounted energy-storing power supply.

### Related Art

Energy-storing power supplies are usually used in outdoor activities that are far away from the mains or are not convenient to connect wires, such as camping in the wild, outdoor adventures and so on. Meanwhile, the energy-storing power supplies can also play an important role in power outage emergency and emergency relief. At present, the vehicle-mounted energy-storing power supply is one of the energy storage power supplies, which is mainly used to help the vehicle start when the vehicle is turned off or anchored and cannot start the vehicle.

A vehicle energy-storing power supply in the prior art comprises a battery box and a bottom cover, wherein the battery box is used to place the battery, and the bottom cover is used to seal the bottom of the battery box, which plays a role in fixing the battery. The current vehicle-mounted energy-storing power supply still has certain problems, specifically, the bottom cover and the bottom of the battery are installed tightly, which will affect the heat dissipation effect of the bottom of the battery, further affects the normal use of the battery, and even reduce the service life of the battery.

### SUMMARY

A number of embodiments of the present disclosure are described herein in summary. However, the vocabulary expression of the present disclosure is only used to describe some embodiments (whether or not already in the claims) disclosed in this specification, rather than a complete description of all possible embodiments. Some embodiments described above as various features or aspects of the present disclosure may be combined in different ways to form a vehicle-mounted energy-storing power supply or a portion thereof.

In order to solve the problems existing in the prior art, the present disclosure provides a vehicle-mounted energy-storing power supply.

The vehicle-mounted energy-storing power supply comprises a power supply main body with an accumulator disposed therein, a bottom cover disposed under the power supply main body, and a heat dissipating and dustproof device disposed on the bottom cover comprising a sealed outer frame and a cooling tube filled with coolant. The inside of the sealed outer frame is a hollow structure for accommodating the cooling tube to cool the accumulator.

The vehicle-mounted energy-storing power supply comprises a power supply main body with an accumulator disposed therein, a bottom cover disposed under the power supply main body, and a heat dissipating and dustproof device disposed on the bottom cover comprising a sealed outer frame and a cooling tube filled with coolant. The inside of the sealed outer frame is a hollow structure for accommodating the cooling tube to cool the accumulator.

Preferably, the bottom cover further comprises a limit frame disposed on the bottom cover for accommodating the accumulator, so that there is a predetermined space between the accumulator and the bottom cover.

Preferably, the area ratio of the opposite surfaces between the hollow structure and the accumulator is 2:3 to 2:1.

Preferably, the vehicle-mounted energy-storing power supply further comprises at least one undertaken tube. When the number of the cooling tube is multiple, the multiple cooling tubes are at least a part in the same plane and are spaced apart from each other, and the two adjacent cooling tubes are connected by the at least one undertaken tube.

Preferably, the inner diameter of the cooling tube is bigger than the outer diameter of the undertaken tube.

Preferably, when the undertaken tube is passed through the cooling tube in connection part of the cooling tubes and the undertaken tube, and the undertaken tube has at least one hole formed in the connection portion inner the cooling tube.

Preferably, the inner diameter of the cooling tube is smaller than the outer diameter of the undertaken tube or equal to the outer diameter of the undertaken tube.

Preferably, the cooling tube is a ring tube connected from end to end.

Preferably, the cooling tube is a high-temperature resistant glass tube.

Preferably, the cross-section outer diameter of the cooling tube is same.

Preferably, the vehicle-mounted energy-storing power supply further comprises a water-storing tank filled with coolant disposed on the undertaken tube to provide the undertaken tube and the cooling tube with coolant.

Preferably, the vehicle-mounted energy-storing power supply further comprises a filter disposed inside the sealed outer frame and located under the cooling tube to dissipate heat for the accumulator and prevent dust from the cooling tube.

Preferably, the bottom cover further comprises a guiding groove disposed outside of the sealed outer frame, a stopper disposed on the surface of the guiding groove, and a quick-release component disposed on the surface of the guiding groove opposite to the stopper comprising a misplaced rod with one end disposed on the lower surface of the sealed outer frame, a resilient rod disposed at the other end of the misplaced rod being elastically forced to close to or away from the stopper, a control rod with one end connected to the resilient rod and the other end formed outside the guiding groove for deform the resilient rod, enabling the quick-release component to be close to or away from the stopper. The quick-release component further comprises a resistance block disposed on the resilient rod.

When the filter is installed on the sealed outer frame, the control rod is forced towards the direction of the filter to deform the resilient rod to drive the resistance block fasten with the stopper, so that the filter is engaged to the sealed outer frame.

When the filter is released from the sealed outer frame, the control rod is forced towards the opposite direction of the filter to deform the resilient rod to drive the resistance block away from the stopper, so that the filter is departed away from the sealed outer frame.

Compared with the prior art, the beneficial effects of the present disclosure are as below:

1. The present disclosure exists space between an accumulator and an bottom cover, and meanwhile disposes positioned space and a cooling tube between the accumulator and the bottom cover, so that heat generated by the accumulator can be quickly dissipated and the cooling tube can continuously dissipate heat for the accumulator then ensuring the accumulator normally operation.

2. The structural designs of the present disclosure can quickly fasten and release between a bottom cover and a filter, so that an operator can clean the filter conveniently.

On the advantages and the spirit of the present disclosure, it can be understood further by the following disclosure descriptions and attached drawings.

### BRIEF DESCRIPTION OF THE DRAWINGS

In order to more clearly explain the embodiment of the present disclosure or the technical scheme in the prior art, the following will briefly introduce the attached drawings that need to be used in the embodiment. It is obvious that the attached drawings in the following description are only some embodiments of the present disclosure. For ordinary technicians in the art, without paying creative labor, other drawings can also be obtained from these drawings.

FIG. 1 illustrates a three-dimensional structural diagram of a vehicle-mounted energy-storing power supply of the present disclosure.

FIG. 2 illustrates a sectional view along the 1-1 sectional plane depicted in FIG. 1.

FIG. 3 illustrates a three-dimensional sectional view of the bottom cover of the present disclosure.

### DETAILED DESCRIPTION

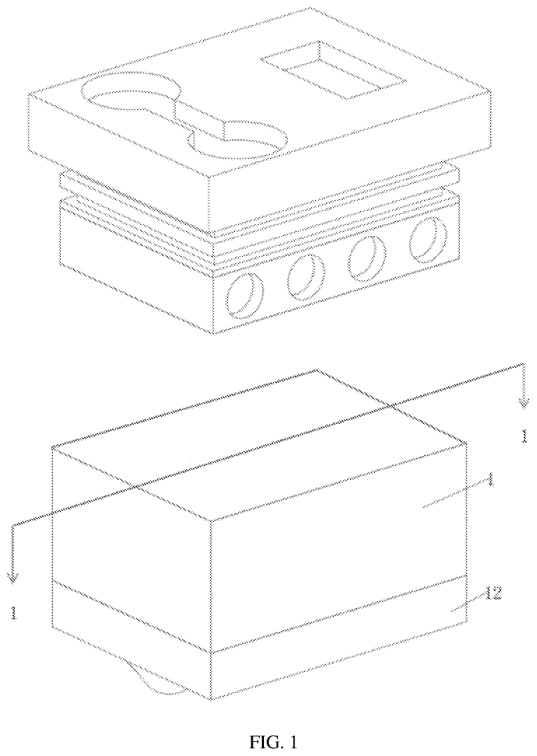

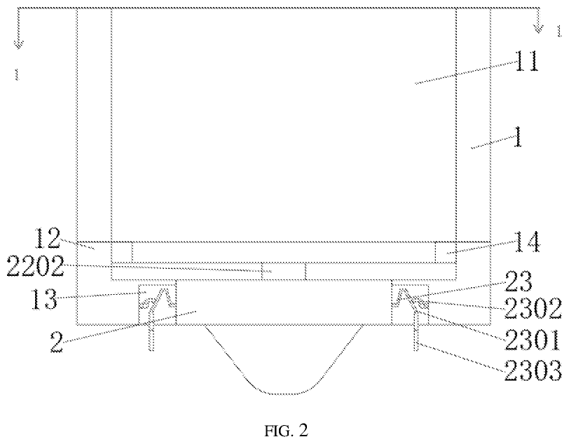

The present disclosure will be described below in detail in combination with preferred embodiments and attached drawings as shown in FIG. 1 to FIG. 3. FIG. 1 illustrates a three-dimensional structural diagram of a vehicle-mounted energy-storing power supply of the present disclosure; FIG. 2 illustrates a sectional view along the 1-1 sectional plane depicted in FIG. 1;

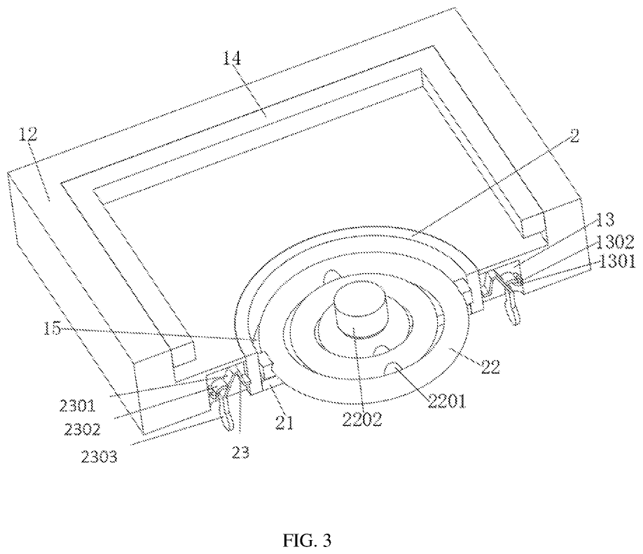

FIG. 3 illustrates a three-dimensional sectional view of the bottom cover of the present disclosure. The present disclosure provide a vehicle-mounted energy-storing power supply which comprises power supply main body 1 and heat dissipating and dustproof device with the heat dissipating and dustproof function.

The power supply main body 1 is disposed a accumulator 11 inside the power supply main body 1 and connected with the accumulator 11 by means of glue, machine and so on. Also, the power supply main body 1 is disposed a bottom cover 12 at the bottom of the power supply main body 1. In some embodiments, the power supply main body 1 is connected with the bottom cover 12 by means of locking, snapping, welding and so on.

As shown in FIG. 2 and FIG. 3, the bottom cover 12 comprises a limit frame 14, a guiding groove 13, a stopper 1301 and a quick-release component.

The limit frame 14 is disposed on the inner of the bottom cover 12 and connected with the bottom cover 12 by screw. In some embodiments, the limit frame 14 is connected with the bottom cover 12 by welding, welding, snapping and other connection means. Also, the limit frame 14 is disposed an accumulator 11 on the limit frame 14 to ensure space existed between the accumulator 11 and the bottom cover 12 to dissipate heat for the accumulator 11.

The guiding groove 13 is disposed in the bottom cover 12.

The stopper 1301 is disposed on the surface of the connection surface 1302, and the stopper 1301 is connected with the bottom cover 12 by screw or snapping or welding. In some embodiments, the stopper 1301 is integrally formed with the bottom cover 12.

The quick-release component is disposed opposite to the stopper 1301 on the surface of guiding groove 13 and comprises a misplaced rod 23, a resistance block 2302, a resilient rod 2301 and a control rod 2303.

The misplaced rod 23 is disposed in the misplaced rod 23, and one end of the misplaced rod 23 is connected on the lower surface of the outside surface of the sealed outer frame 2 by screw or plugging or melding or other connection means.

The resilient rod 2301 is disposed at the other end of the misplaced rod 23 and can be elastically forced to close to or away from the stopper. The resilient rod 2301 is connected with the misplaced rod 23 by screw or plugging or snap or other connection means. Also, the resilient rod 2301 is integrally formed with the misplaced rod 23.

The resistance block 2302 is disposed on the surface of the resilient rod 2301 and connected with the resilient rod 2301 by screw or plugging or snapping or other connection means. Also, the resistance block 2302 is integrally formed with the resilient rod 2301.

The control rod 2303 connected with the resilient rod 2301 is used to deform the resilient rod 2301, enabling the quick-release component to be close to or away from the stopper 1301. The control rod 2303 is connected with the resilient rod 2301 by screw or plugging or snapping or other connection means. Also, the control rod 2303 is integrally formed with the resilient rod 2301.

The heat dissipating and dustproof device of the present disclosure is disposed in the bottom of the power supply main body 1. The heat dissipating and dustproof device having heat dissipating and dustproof effects on the accumulator 11 comprises a sealed outer frame 2, a filter 21 and a cooling tube 22.

The sealed outer frame 2 is disposed in the bottom cover 12 and the inside of the sealed outer frame 2 is a positioned groove 15 which is a hollow structure. The positioned groove 15 is disposed the cooling tube 22, the filter 21 and the accumulator 11.

The cooling tube 22 is continuously dissipated heat for the accumulator 11.

If the sealed outer frame 2 is a closed structure, heat generated by the accumulator 11 is unable to be dissipated to the external environment and then the temperature of the cooling tube 22 quickly rises, so that the heat dissipating capability of the cooling tube 22 and the capability of the accumulator 11 are reduced.

Because the inside of the sealed outer frame 2 is a hollow structure, the cooling tube 22 accommodated in the sealed outer frame 2 can dissipate the heat generated by the accumulator 11 to the external environment and will not cause the temperature of the cooling tube 22 to rise, and then the cooling tube 22 and the accumulator 11 are dissipated at the same time and the cooling tube 22 can dissipate heat for the accumulator 11 quickly.

Preferably, the sealed outer frame 2 is disposed at the bottom of the bottom cover 12. In this embodiment, the area ratio of the opposite surfaces of the positioned groove 15 and the accumulator 11 is 2:3 to 2:1. In this area range, the positioned groove 15 can provide enough area to dispose the cooling tube 22 and the accumulator 11 to play part in heat dissipating and dustproof effects on the cooling tube 22 and the filter 21. In this embodiment, the shape of the positioned groove 15 which can be round or square is disposed to match the shape of the bottom of the accumulator 11. In this embodiment, as long as the area ratio of the opposite surface between the positioned groove 15 and the accumulator 11 in the present disclosure is satisfied, other designed shapes are also possible, which will not be described below in detail.

The outside of the sealed outer frame 2 of the present disclosure further has an guiding groove 13 to seal the outer frame 2. The sealing frame 2 is used to accommodated and install the cooling tube 22, the filter 21 and the misplaced rod 23. In an embodiment, the material of the sealed outer frame 2 is plastic.

The cooling tube 22 is internally filled with coolant to dissipate heat for the accumulator 11. The number of cooling tube 22 of the present disclosure can be one or more. In some embodiments, the cooling tube 22 is an end-to-end annular tube, and the coolant can be flowed inside the annular tube. When using a plurality of cooling tubes 22, at least one undertaken tube 2201 is disposed between the cooling tubes 22. The cooling tube 22 can be connected to the undertaken tube 2201 by screw, threading, snapping and so on, and the cooling tube 22 can be connected to the sealed outer frame 2 by plugging, butting, snapping and so on.

In some embodiments, the cross-section inner diameter of the annular tube of the cooling tube 22 is bigger than the cross-section outer diameter of the undertaken tube 2201. The cooling tube 22 of the present disclosure is a high-temperature resistant glass tube, so that the cooling tube 22 will not crack in the heat dissipation process of the accumulator 11 and the heat exchange process of the cooling tube 22 and the accumulator 11.

In other embodiments, the cooling tube 22 can also be a annular tube that is not connected end to end, and the cooling tube 22 is disposed in the sealed outer frame 2 and above the filter 21. As long as the annular tube of the cooling tube 22 can be filled with coolant to achieve the effect of heat dissipation on the accumulator 11, structural design changes of the cooling tube 22 are all the present disclosure and will not be repeated below.

In some embodiments, the disposition of the plurality of the cooling tubes 22 of the present disclosure is described by taking three cooling tubes 22 as an example to illustrate the plurality of cooling tubes 22. In this embodiment, as shown in FIG. 3, the three cooling tubes 22 have the same cross-section outer diameter and are spaced apart from each other. The cross-section inner diameter of the annular tube of the three cooling tubes 22 is larger than the cross-section outer diameter of the undertaken tube 2201. The outer diameters of the three cooling tubes 22 on their respective planes are gradually decreased. Therefore, when at least a part of the three cooling tubes 22 are in the same plane, the three cooling tubes 22 are passed through in connection part of the three cooling tubes 22 and the undertaken tube 2201 by the undertaken tube 2201 and are connected by plugging. Further, the three cooling tubes 22 are connected with the undertaken tube 2201 to fill with the coolant. The cooling tube 22 with the biggest outer diameter is connected in the sealed outer frame 2 by plugging.

In some embodiments, the inner diameter of the annular tube of the three cooling tubes 22 are less than or equal to the outer diameter of the undertaken tube 2201. When the outer surface of the three cooling tubes 22 are in a same plane, the undertaken tube 2201 is connected on this plane of the three cooling tubes 22, and the undertaken tube 2201 has at least one hole formed in the connection portion inner the cooling tube 22. The three cooling tubes 22 can also be connected by the undertaken tube 2201 with second largest or smallest outer diameter.

Also, the three cooling tubes 22 can be connected in the sealed outer frame 2 or on the on the inside of the sealed outer frame 2. The present disclosure by means of a plurality of cooling tubes 22 can strengthen the heat dissipation effect on the accumulator 11 to ensure the normal operation of the accumulator 11.

By using a plurality of cooling tubes 22, the heat dissipating area of the cooling tubes 22 is increased and the heat dissipation effect of the cooling tubes 22 on the accumulator 11 is increased, thereby ensuring the normal operation of the accumulator 11.

The area ratio of the opposite surface of the cooling tube 22 and the accumulator 11 is 2:3 to 2:1. In this area range, the heat dissipation effect of the cooling tube 22 on the accumulator 11 can be well effective.

The undertaken the tube 2201 of the present disclosure is a hollow tube structure. The connection means of the undertaken tube 2201 and the cooling tube 22 is disposed from the surface of the cooling tube 22 through the cooling tube 22. At this time, the undertaken tube 2201 has at least one hole formed in the connection portion inner the cooling tube 22. The surface of the middle of the undertaken tube 2201 is disposed a water-storing tube 2202. The undertaken tube 2201 is connected to the water-storing tube 2202 by screw, and the undertaken tube 2201 also has at least one hole formed in the connection portion inner the water-storing tube 2202. Thus, the undertaken tube 2201 enables the coolant within the water-storing tube 2202 to flow through the hole of the undertaken tube 2201 inner the water-storing tube 2202 and through the hole of the undertaken tube 2201 inner the cooling tube 22, and then the coolant flow into the inside of the cooling tube 22. The material of the undertaken tube 2201 can be glass or plastic. Also, the cross-section outer diameter of the undertaken tube 2201 can be bigger, less than or equal to the inner diameter of the annular tube of the cooling tube 22.

In other embodiments, the undertaken tube 2201 can be connected to the water-storing tube 2202 by plugging, docking snapping and so on. The connecting position of the undertaken tube 2201 and the water-storing tube 2202 can be on the surface of the middle of the undertaken tube 2201, or the connecting position of the undertaken tube 2201 is the surface not connected to the cooling tube 22.

The water-storing tube 2202 is filled with the coolant, so that the water-storing tube 2202 can provide coolant for the undertaken tube 2201 and the cooling tube 22.

In some embodiments, the coolant within the water-storing tube 2202 is poured into the undertaken tube 2201 from the hole in the undertaken tube 2201, and then the coolant flows into the inside of the cooling tube 22 through the undertaken tube 2201. When the coolant inside of the cooling tube 22 and the undertaken tube 2201 meets the required amount, the water-storing tube 2202 and the undertaken tube 2201 are connected to prevent the coolant flowing out of the cooling tube 22 and the undertaken tube 2201.

In another embodiment, the means of the water-storing tube 2202 providing coolant to the undertaken tube 2201 and the cooling tube 22 can also be that when the water-storing tube 2202 is equipped with coolant, the water-storing tube 2202 is connected to the undertaken tube 2201 below the undertaken tube 2201. And then the water-storing tube 2202 and the undertaken tube 2201 are inverted, so that the coolant inside the water-storing tube 2202 can flow into the interior of the undertaken tube 2201 and the cooling tube 22.

The filter 21 is disposed inside the sealed outer frame 2 and located under the cooling tube 22, and the filter 21 is connected to the sealed outer frame 2 by screw, plugging or snapping, and so on. The filter 21 has the function of ventilating and filtering dust in the external environment.

As known, there is much dust out of the working environment of the energy-storing power supply.

On one hand, it is easy to make the surface of the cooling tube 22 full of dust, which results the heat dissipating capacity of the coolant inside the cooling tube 22 on the accumulator 11 greatly reduced. On the other hand, it's easy to cause the accumulator 11 to absorb dust and affect other performance of the accumulator 11.

Therefore, the filter 21 is disposed below the cooling tube 22, so that the filter 21 can not only maintain the normal ventilation and heat dissipation for the accumulator 11 and the cooling tube 22, but also filter out the dust in the working environment, maintain the good heat dissipation function of the cooling tube 22 to the accumulator 11 and the good heat dissipation function and other properties of the accumulator 11.

The working principle of the present disclosure is using the positioned space 15 to provide a cooling tube 22 filled with coolant to dissipate heat for the accumulator 11 to ensure the normal operation of the accumulator 11.

When installed in sealed outer frame 2, the filter 21 is located at the lower side of the inner of the sealed outer frame 2 with a cooling tube 22, and forced to control the control rod 2303 towards the direction of the filter 21, so that the resilient rod 2301 is deformed to drive the resistance block 2302 to snap the stopper 1301, and then the sealed outer frame 2, the cooling tube 22 and the filter 21 are secured in the bottom cover 12.

Also, when the filter 21 is released from the sealed outer frame 2, the force is applied to the control rod 2303 towards the opposite direction of the filter 21, the resilient rod 2301 is deformed to drive the resistance block 2302 away from the stopper 1301, so that the sealed outer frame 2 can be quickly taken out from the inside of the bottom cover 2, and the filter 21 is departed away from the sealed outer frame 2.

Compared with the prior art, the beneficial effects of the present disclosure are as below:

1. The present disclosure exists space between an accumulator and an bottom cover, and meanwhile disposes positioned space and a cooling tube between the accumulator and the bottom cover, so that heat generated by the accumulator can be quickly dissipated and the cooling tube can continuously dissipate heat for the accumulator then ensuring the accumulator normally operation.

3. The structural designs of the present disclosure can quickly fasten and release between a bottom cover and a filter, so that a operator can clean the filter conveniently.

It should be noted that the present disclosure is not limited to the above embodiments. According to the creative spirit of the present disclosure, those skilled in the art can also make other modifications, which should not be interpreted as limiting the scope of the present disclosure. It should be noted that all modifications and substitutions equivalent to the embodiment should be included in the scope of the present disclosure. Therefore, the scope of protection of the present disclosure shall be subject to the scope defined in the claims.

What is claimed is:

1. A vehicle-mounted energy-storing power supply, comprising:
a power supply main body with an accumulator disposed therein;
a bottom cover disposed under the power supply main body;
a heat dissipating and dustproof device disposed in the bottom cover, comprising a sealed outer frame and a cooling tube filled with coolant;
wherein the inside of the sealed outer frame is a hollow structure for accommodating the cooling tube to cool the accumulator.

2. The vehicle-mounted energy-storing power supply of claim 1, wherein the bottom cover further comprises a limit frame disposed on the bottom cover for accommodating the accumulator, so that there is a predetermined space between the accumulator and the bottom cover.

3. The vehicle-mounted energy-storing power supply of claim 2, wherein the area ratio of the opposite surfaces between the hollow structure and the accumulator is 2:3 to 2:1.

4. The vehicle-mounted energy-storing power supply of claim 3, further comprising at least one undertaken tube; wherein when the number of the cooling tube is multiple, the multiple cooling tubes are at least a part in the same plane and are spaced apart from each other, and the two adjacent cooling tubes are connected by the at least one undertaken tube.

5. The vehicle-mounted energy-storing power supply of claim 4, wherein the inner diameter of the cooling tube is bigger than the outer diameter of the undertaken tube.

6. The vehicle-mounted energy-storing power supply of claim 5, wherein when the undertaken tube is passed through the cooling tube in connection part of the cooling tubes and the undertaken tube, and the undertaken tube has at least one hole formed in the connection portion inner the cooling tube.

7. The vehicle-mounted energy-storing power supply of claim 4, wherein the inner diameter of the cooling tube is smaller than the outer diameter of the undertaken tube or equal to the outer diameter of the undertaken tube.

8. The vehicle-mounted energy-storing power supply of claim 1, wherein the cooling tube is a ring tube connected from end to end.

9. The vehicle-mounted energy-storing power supply of claim 1, wherein the cooling tube is a high-temperature resistant glass tube.

10. The vehicle-mounted energy-storing power supply of claim 1, wherein the cross-section outer diameter of the cooling tube is same.

11. The vehicle-mounted energy-storing power supply of claim 4, further comprising a water-storing tank filled with coolant disposed on the undertaken tube to provide the undertaken tube and the cooling tube with coolant.

12. The vehicle-mounted energy-storing power supply of claim 1, further comprising a filter disposed inside the sealed outer frame and located under the cooling tube to dissipate heat for the accumulator and prevent dust from the cooling tube.

13. The vehicle-mounted energy-storing power supply of claim 12, wherein the bottom cover further comprises:
a guiding groove disposed outside of the sealed outer frame;
a stopper disposed on the surface of the guiding groove;
a quick-release component disposed on the surface of the guiding groove opposite to the stopper comprising:
a misplaced rod with one end disposed on the lower surface of the sealed outer frame;
a resilient rod disposed at the other end of the misplaced rod being elastically forced to close to or away from the stopper;
a control rod with one end connected to the resilient rod and the other end formed outside the guiding groove for deform the resilient rod, enabling the quick-release component to be close to or away from the stopper;
Wherein the quick-release component further comprises a resistance block disposed on the resilient rod; when the filter is installed in the sealed outer frame, the control rod is forced towards the direction of the filter to deform the resilient rod to drive the resistance block fasten with the stopper, so that the filter is secured to the sealed outer frame; and when the filter is released from the sealed outer frame, the control rod is forced towards the opposite direction of the filter to deform the resilient rod to drive the resistance block away from the stopper, so that the filter is departed away from the sealed outer frame.
